(19) United States
(12) Patent Application Publication
(10) Pub. No.: US 2014/0046488 A1
(43) Pub. Date: Feb. 13, 2014

(54) CONSTRUCTION MACHINE WITH SENSOR UNIT

(71) Applicant: JOSEPH VOEGELE AG, Ludwigshafen/Rhein (DE)

(72) Inventors: Achim Eul, Mannheim (DE); Jens Herrmann, Zeiskam (DE)

(73) Assignee: JOSEPH VOEGELE AG, Ludwigshafen/Rhein (DE)

(21) Appl. No.: 13/963,289

(22) Filed: Aug. 9, 2013

(30) Foreign Application Priority Data
Aug. 10, 2012 (EP) 12 005 820.1

(51) Int. Cl. G05B 13/02

(52) U.S. Cl. CPC G05B 13/02
USPC 700/275

(57) ABSTRACT

A construction machine includes at least one sensor unit which can assume different measuring states and at least one operating device spatially separated therefrom, with which a measuring state of the sensor unit is controllable. Additional controls are arranged at the at least one sensor unit, and the measuring state of the at least one sensor unit is controllable by both the at least one operating device as well as by the controls at the at least one sensor unit. A method for controlling at least one sensor unit, which can assume different measuring states, on a construction machine is also provided. The method includes controlling the measuring state of the at least one sensor unit both by at least one operating device spatially separated from the at least one sensor unit, and by controls attached to the at least one sensor unit itself.

### CROSS-REFERENCE TO RELATED APPLICATIONS

This application claims foreign priority benefits under 35 U.S.C. §119(a)-(d) to European patent application number EP 12005820.1, filed Aug. 10, 2012, which is incorporated by reference in its entirety.

### TECHNICAL FIELD

The disclosure relates to construction machines and methods for controlling sensor units of such construction machines.

### BACKGROUND

Such construction machines are known in practice. The sensor units serve to monitor various operating parameters of the construction machine and its work results. In addition, various operating parameters of the construction machine can be adjusted based on the data obtained, so as to achieve the best possible work results.

### SUMMARY

The disadvantage of the conventional construction machines is that the concept for operating the sensor units is tailored to a specific application scenario. Differing scenarios, different construction site situations and different ways operators work can therewith not be considered.

An object of the present disclosure is to provide a construction machine with at least one sensor unit, of which the design is improved in the simplest way possible in order to enable adaptation of the concept of operation to the aforementioned factors.

The construction machine according to the disclosure is characterized in that the sensor units used are controllable both by one or more operating devices spatially separated thereform, and by controls attached to the sensor unit itself This makes operating the construction machine much more flexible. Any predetermination of one fixed operating concept is no longer necessary. Rather, the operator is enabled to adapt the operation to the situation and to set it up according to his ideas. For the user of the construction machine, this results in the advantages of a more efficient operation and, by avoiding operating errors, in a better quality of the work result. And this can in addition to the increased customer value yield advantages also for the manufacturer. Due to the fact that one and the same machine configuration can cover several operating concepts, for example, the number of variants can be reduced.

It is advantageous if the measuring state of the sensor unit is controllable relative to the current measuring state. This, for example, enables an operator of the machine to respond flexibly to situation changes without knowing the respective current measuring state of the sensor unit. This can be an advantage, particularly during operation of large construction machines by several operators.

Measuring state is here used as a representative for all adjustable parameters of the respective sensor unit, such as control parameters, target values, but also sample rates or sensitivities. By way of example, but not in a restricting manner, intelligent sensor units are to be mentioned that already perform a target value comparison. In a distance sensor, the target distance can be changed incrementally without setting a new absolute target distance. The same applies, for example, for leveling, temperature, brightness or pressure sensors. Another non-restricting example are sensor units whose measuring principle is based on wave phenomena, e.g., ultrasonic sensors. Here, for example, the wave frequency and wave amplitude, or for ultrasound the magnitude of the ultrasound beam can be adjusted incrementally starting from a current state without having to enter an absolute value.

It is useful if the measurement state of the sensor unit is storable by a central memory. Synchronization of multiple memories is thereby unnecessary, despite being able to operate the sensor unit from multiple locations.

It is very advantageous, when a test block is provided and configured to subject the control input to a review procedure prior to its implementation. This avoids conflicts between different data inputted at different locations, e.g., in that it is organized hierarchically. In this manner, an input performed at the sensor unit can be given a higher hierarchy than the input performed at an operating device, and vice versa. However, the hierarchy can also be organized according to other criteria, such as input time, direction of adjustment or according to combinations of various criteria. The system can be configured such that input is implemented in dependency of its hierarchy, e.g., that when control data is inputted at the same or nearly the same time, only that which is ranked higher in the hierarchy is implemented.

The sensor unit can e.g., comprise a distance sensor.

In a further variant of the disclosure, the sensor unit comprises an ultrasonic sensor. They offer the advantage that they can perform various contact-free measurements, for example, using transit-time measurement. That includes e.g., distances, layer thicknesses or flow rates.

It is conceivable that the sensor unit is used as a material sensor that can detect the amount of material at a specific location at, in or in the vicinity of the machine. This can for example be done by measuring distances, filling levels or weight. It is also conceivable that the sensor unit can be used e.g., as a leveling or elevation sensor for height control.

For actuation, the controls can comprise, for example, a push-button assembly or a potentiometer.

For controlling the measuring state of the sensor unit, the operating device can also comprise, for example, a potentiometer or a push-button assembly.

In both cases, it is advantageous to have the push-button assembly include one push-button for each possible direction of change, e.g., for any change in a target value have one button to increase and one to reduce the target value. ,Likewise, it is advantageous when using a potentiometer, to assign each rotating direction to a certain direction of change.

The construction machine can for example be a road finisher or a feeder.

The disclosure also relates to a method for controlling at least one sensor unit, which is adapted for assuming different measuring states, at a construction machine. With the method, the measuring state of the least one sensor unit is controlled both by at least one operating device spatially separated therefrom, and by controls attached to the sensor unit itself.

Preferably, the at least one sensor unit is controlled relative to a current measuring state, so that the measuring state can be changed incrementally, as opposed to an input of absolute values.

It is advantageous if the current measuring state of the at least one sensor unit is stored centrally.

It is particularly advantageous when the control input undergoes a review process before it is implemented, so as to avoid conflicts between differing control input.

In another advantageous variant of the disclosure, the at least one sensor unit measures a distance, preferably by using ultrasound. However, it can also measure, for example, height, an inclination, temperature, brightness or pressure.

The disclosure relates to a construction machine with at least one sensor unit and to a method for controlling the at least one sensor unit at a construction machine of the kind described above.

In the following, an advantageous embodiment of the disclosure is further illustrated by means of drawings.

### BRIEF DESCRIPTION OF THE DRAWINGS

FIG. 1 shows a side view of a construction machine, in this example, a road finisher. However, it can also be a different construction machine;

FIG. 2 shows a plan view of an operating device for controlling sensor units on a construction machine;

FIG. 3 shows a perspective view of a sensor unit with controls; and

FIG. 4 shows a schematic illustration of the signal flow between the various system components.

### DETAILED DESCRIPTION

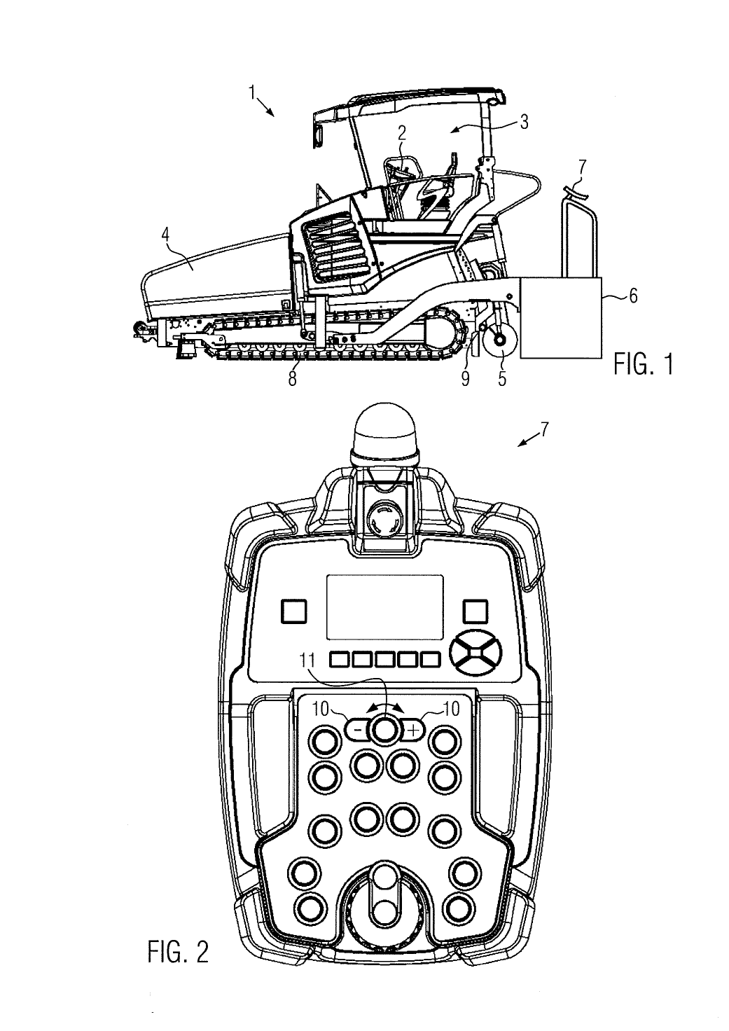

In the embodiment illustrated, the construction machine 1 shown in FIG. 1 comprises an operating device 2 in the form of an operator's console, which is arranged in the region of a driver's station 3. The construction machine 1 is a road finisher. It is used for installing road pavements. For this purpose, a preceding vehicle, for example a feeder, deposits a so-called mix in a material hopper 4. The mix is from there conveyed by so-called scraper conveyors—not shown—underneath the driver's stations 3 to a material distribution auger 5. They distribute the mix to the desired paving width. It is then compacted and leveled by a screed 6.

A second operating device 7 is mounted to the screed 6 in the form of an exterior control station. The road finisher 1 is driven by a chain drive 8. A sensor unit 9 is in this embodiment provided as a material sensor in the region of the material distribution auger 5. In this case, the sensor unit 9 is used to detect the material quantity that is located in front of the material distribution auger 5. Operation of the material distribution auger 5 is then controlled based on the measurement values obtained. According to the disclosure, a sensor unit 9 can, however, be used for any purpose at any location of the construction machine 1.

FIG. 2 shows the second operating device 7, which has both a push-button assembly 10, and a potentiometer 11 arranged on it for controlling the sensor unit 9. Just as well, however, only one of the two components could be used.

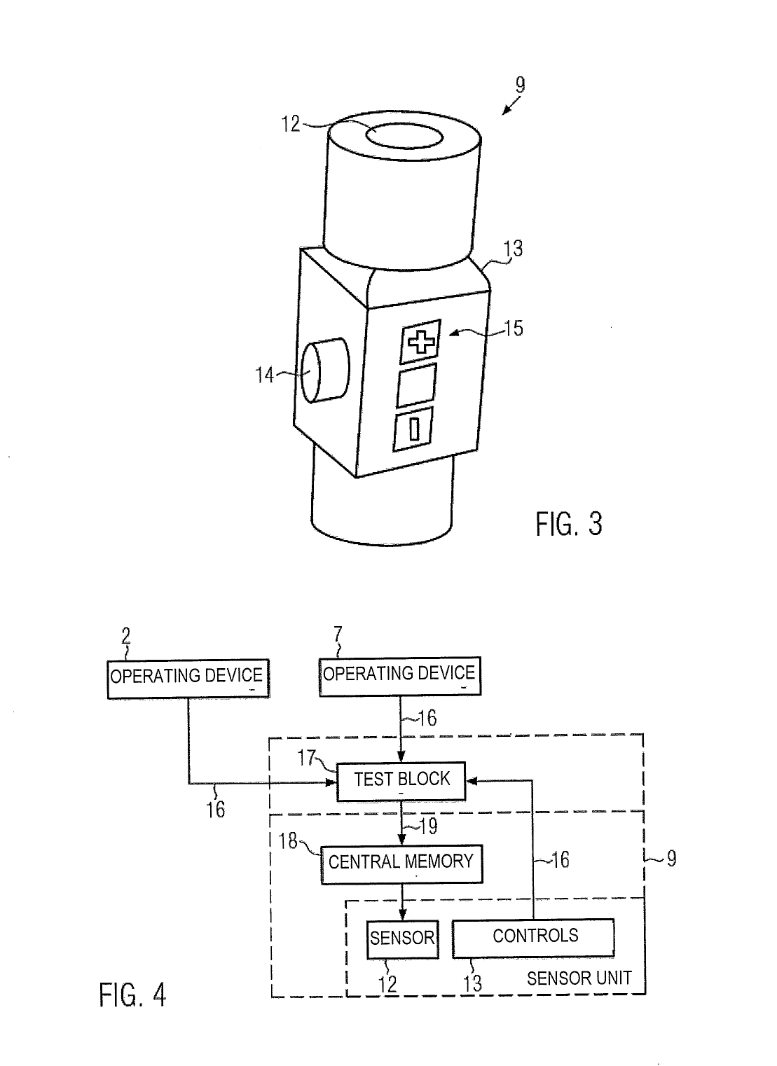

FIG. 3 shows the sensor unit 9 in detail. In the present embodiment, it comprises a distance sensor 12 being embodied as an ultrasonic sensor. However, it can comprise any other type of sensor with any arbitrary measuring principle. Moreover, the sensor unit 9 comprises controls 13, on which both the potentiometer 14 as well as a push-button assembly 15 are provided for actuation. Just like with the operating device 7, however, here as well, only one of the two can alternatively be used.

FIG. 4 schematically shows the signal flow between the various system components. In this embodiment, two operating devices 2, 7 are provided. Control input 16 is generated by one of the operating devices 2, 7 or by controls 13 at the sensor unit 9 and passed on to a test block 17. Possibly occurring conflicts between the different control inputs 16 are managed there. In the event of control input being inputted at the same or nearly the same time, the input performed at the sensor unit 9 is implemented with priority. Alternatively, one of the operating devices 2, 7 whose input is given preference can be selected prior to starting the installation. In this manner, it can be decided depending on the situation, which operator has the best view. Thereafter, the measuring state of the sensor unit 9 is adjusted in a central memory 18 based on an output signal 19 of the test block 17. The measuring state of the sensor unit 9 is then set according to the state now stored in the central memory 18.

The dashed lines represent various options for the housing assembly of the various components. According thereto, the sensor 12 and the controls 13 are combined in a common housing to form the sensor unit 9. In addition, it is possible to arrange the central memory 18 and/or the test block 17 in the same housing. The operating devices 2, 7, however, are in any case spatially separated from the sensor unit 9.

In another variant, a plurality of sensor units 9 is arranged along the material distribution auger 5. For large paving widths, the material quantity in front of the material auger 5 can thereby be controlled to a much finer degree.

Another version represents a road finisher 1, where the sensor unit 9 measures the temperature of the mix or the material, respectively. If an operator being on the screed 6 recognizes a cooling of the material, then he can perform adjustments directly from the external control station 7 without having to enter the driver's stations 3, or instructing a colleague there.

In further variants, the construction machine 1 can be a road finisher or a feeder for which the sensor unit 9 measures the vehicle speed.

In an additional variant, the construction machine 1 is a feeder in which the sensor unit 9 measures the conveying speed at which the mix is deposited in the material hopper 4 of the road finisher. In this, an operating device 2, 7 is mounted at a position on the feeder from which an operator can observe the material hopper 4 of the following road finisher. This enables the operator to adapt the feed rate to the filling level of the material hopper 4.

In further variants, the construction machine 1 can be a road finisher or a feeder in which the sensor unit 9 measures the height using an elevation sensor.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A construction machine comprising:
a sensor unit that can assume different measuring states; and
an operating device spatially separated from the sensor unit, with which a measuring state of the sensor unit is controllable;
wherein the sensor unit includes additional controls, and the measuring state of the sensor unit is controllable by both the operating device, as well as by the additional controls.

2. The construction machine according to claim 1 wherein the sensor unit is controllable relative to a current measuring state.

3. The construction machine according to claim 1 wherein the measuring state of the sensor unit is storable by a central memory.

4. The construction machine according to claim 1 further comprising a test block configured to subject control input to a review procedure prior to implementation of the control input.

5. The construction machine according to claim 1 wherein the sensor unit comprises a distance sensor.

6. The construction machine according to claim 1 wherein the sensor unit comprises an ultrasonic sensor.

7. The construction machine according to claim 1 wherein the sensor unit is employable as a material sensor or as an elevation sensor.

8. The construction machine according to claim 1 wherein the additional controls comprise a push-button assembly and/or a potentiometer.

9. The construction machine according to claim 1 wherein the operating device comprises a potentiometer and/or a push-button assembly for controlling the measuring state of the sensor unit.

10. The construction machine according to claim 1 wherein the construction machine is a road finisher or a feeder.

11. A method for controlling at least one sensor unit, which can assume different measuring states, on a construction machine, the method comprising:
controlling the measuring state of the at least one sensor unit both by at least one operating device spatially separated from the at least one sensor unit, and by controls attached to the at least one sensor unit itself.

12. The method according to claim 11 wherein controlling the at least one sensor unit is performed relative to a current measuring state.

13. The method according to claim 12 wherein the current measuring state of the at least one sensor unit is centrally stored.

14. The method according to claim 11 wherein control input is subjected to a review procedure before being implemented.

15. The method according to claim 11 wherein the at least one sensor unit is configured to measure a distance.

16. The method according to claim 11 wherein the at least one sensor unit is configured to measure a distance using ultrasound.
